(19) United States
(12) Patent Application Publication
(10) Pub. No.: US 2025/0067507 A1
(43) Pub. Date: Feb. 27, 2025

(54) METHOD AND DEVICE FOR SEPARATING AIR BY CRYOGENIC DISTILLATION

(71) Applicant: L'Air Liquide, Société Anonyme pour l'Etude et l'Exploitation des Procédés Georges Claude, PARIS (FR)

(72) Inventor: Jean-Pierre TRANIER, L'Hay-les-Roses (FR)

(21) Appl. No.: 18/274,146

(22) PCT Filed: Jan. 25, 2022
(86) PCT No.: PCT/EP2022/051578

§ 371 Date: Nov. 12, 2024

(30) Foreign Application Priority Data
Jan. 25, 2021 (FR) 2100666

(51) Int. Cl. F25J 3/04

(52) U.S. Cl. CPC F25J 3/0483; F25J 2230/22; F25J 2230/40; F25J 2280/02

(57) ABSTRACT

A method for separating air by cryogenic distillation wherein, during a first run, a first flow rate of air is compressed in at least one compressor, cooled and separated in a system of columns, a first flow rate of a first distillation product is produced, voltage electricity requirements of the compressor or compressors of the method are met from an electricity grid, during a second run, a second flow rate of air lower than the first flow rate of air is compressed in the compressor, the second flow rate is cooled and separated in the system of columns, a second flow rate of a first distillation product is produced, lower than the first flow rate of the first product, voltage electricity requirements of the compressor being lower than during the first run and, during an intermediate run taking place after the first run and before the second run.

### CROSS REFERENCE TO RELATED APPLICATIONS

This application is a 371 of International Application No. PCT/EP2022/051578, filed Jan. 25, 2022, which claims priority to French Patent Application No. 2100666, filed Jan. 25, 2021, the entire contents of which are incorporated herein by reference.

### BACKGROUND

The present invention relates to a method and to a device for separating air by cryogenic distillation.

Devices for separating air by cryogenic distillation are supplied with large quantities of electricity at high voltage and/or medium voltage for the motors of the air compressors and possibly product compressors.

WO2012056245 describes a method for operation of a power plant supplying an air separation device wherein the power sent to the compressors of the air separation device is varied according to the demand for electricity on the grid. This document provides for load shedding to be applied to the air separation in the event of high demand for electricity on the grid.

Load shedding refers to cutting off the power supply to devices connected to an electricity grid in order to reduce the overall load on the grid. Load shedding may consist of completely cutting off the power supply to a device or reducing its consumption; the latter is referred to as partial load shedding.

It is known practice to supply electricity for an air separation device from a power plant or a nuclear power station.

To cope with fluctuating demand for electricity, aggregators may ask customers to reduce their consumption. Load shedding of consumption consists, in the event of an imbalance in electricity supply and demand, in temporarily reducing the physical consumption of a given site in relation to its “normal” consumption. Load shedding is triggered by an external stimulus, typically during peak periods of daily or seasonal electricity consumption. It can simply smooth out demand for electricity or, in extreme cases, prevent an outage in the supply of electricity.

### SUMMARY

The present invention relates to a method for separating air by cryogenic distillation which is capable of rapidly reducing its consumption of electricity from a grid.

Hitherto, the use of accumulators to supply electricity to the motor of a main compressor of such a device has been unprecedented.

The aim of the invention is not to reduce the maximum consumption of the separation device. Nor is the aim necessarily to consume less power when it is expensive (because this could be achieved without accumulators for a lower investment).

The invention aims primarily to provide a service to the electricity grid through the ability to shed load rapidly (in a few seconds) when there is a lack of electricity production capacity.

When electricity consumption outstrips production, there are three types of reserves for addressing the situation: primary, secondary and tertiary reserves.

In practice, for the secondary reserve (activated automatically by the manager of the electricity grid) and tertiary reserve (activated manually by the operator of the air separation device, following a telephone call from the grid manager), the invention makes it possible to rapidly reduce the power required by the separation device at key moments, thanks to the use of accumulators allowing the modulation of power over periods ranging from 2 to 15 minutes.

The return on investment is based on a service to the grid (in €/MW shed rapidly) and not on the cost of electrical power (unit: €/MWh).

It is known practice to store electrical power in an electrochemical accumulator by conversion into electrochemical energy like a battery, but storing power in an electrochemical accumulator is much more expensive than reducing the electricity consumption of an air separation device. On the other hand, the reaction time of an electrochemical accumulator is faster (a few seconds) than that of an air separation device.

The present invention relates to a method for separating air by cryogenic distillation, wherein its consumption of electricity from a grid may be reduced by using an electrochemical power storage system such as an electrochemical accumulator. This method makes it possible to reduce the power consumption of an air separation device more rapidly. The method preferably uses at least one cryogenic liquid storage means, which may be an air storage means, a liquid oxygen storage means or a liquid nitrogen storage means.

It would be easy to extend this concept to the liquefaction of a cryogenic fluid (O₂, N₂, Ar, CH₄, CO, H₂, He, CO₂, etc.) or to other types of separation by distillation.

The electricity supplied to an air gas separation device may be used for three purposes:
Oxygen/nitrogen and possibly argon separation.
Compression of products internally by the vaporization of oxygen and/or nitrogen and/or argon at high pressure vis-à-vis condensing air at high pressure and/or externally with an oxygen and/or nitrogen and/or argon compressor.
Liquefaction of air gases such as oxygen and/or nitrogen and/or argon with an integrated air cycle or an external nitrogen cycle.

To reduce separation power, the invention proposes, in addition to the use of at least one accumulator, the use of a liquid oxygen storage means and a liquid air or possibly liquid nitrogen storage means as described in FR2924203 and FR3066809. FIG. 5 of FR3066809 depicts the case where liquid oxygen is stored in a storage means upstream of the pump and liquefied air is stored in a liquefied air storage means.

To reduce internal compression power, the invention proposes, in addition to the use of at least one accumulator, the use of a thermal storage means consisting of an inexpensive medium with high thermal capacity by mass and/or volume, for example quartz sand, iron ore pellets or encapsulated solid and/or liquid water. It is also possible to use a means that is more expensive but more effective since it is based on liquid-solid phase change either with pure substances or with mixtures. WO 2010/093400 lists a number of molecules which could be used as phase change materials.

To reduce liquefaction power, the invention proposes, in addition to the use of at least one accumulator, reducing or stopping air compression associated with the air cycle and/or reducing or stopping nitrogen compression associated with the nitrogen cycle.

This method for shedding load in an air gas separation unit makes it possible to achieve rapid variations in power consumption:
As regards reductions (for example at the request of the electricity grid manager to balance supply and demand: primary, secondary or tertiary reserve), the power consumed by the unit from the viewpoint of the grid is reduced rapidly using, for example, batteries to supply energy to the unit, the latter reducing its electricity consumption more slowly than that corresponding to the combined electrical power consumed by the batteries and the unit.
As regards increases, the power consumed by the unit from viewpoint of the grid is increased rapidly using, for example, batteries to store power, the unit increasing its electricity consumption more slowly than that corresponding to the combined electrical power stored by the batteries and the unit.

It is thus possible to have a system operating with two consumption levels with rapid run-change gradients.

WO2015/003809 describes a method according to the preamble of claim 1 but does not present a solution for minimizing the increase in consumption of electricity from the electricity grid upon a change of run which increases consumption.

The subject matter of the invention, according to one aspect, is a method for separating air by cryogenic distillation wherein, during a first run, a first flow rate of air is compressed in at least one compressor, it is cooled and it is separated in a system of columns, a first flow rate of a first distillation product is produced, high or medium voltage electricity requirements of the compressor or compressors of the method are met from an electricity grid, during a second run, a second flow rate of air lower than the first flow rate of air is compressed in the at least one compressor, the second flow rate is cooled and separated in the system of columns, a second flow rate of a first distillation product is produced from the system of columns, lower than the first flow rate of the first product, high or medium voltage electricity requirements of the compressor being lower than during the first run and, during an intermediate run taking place after the first run and before the second run, the consumption of electricity from the electricity grid of the compressor or compressors is lower than that during the first run and greater than or equal to that during the second run, characterized in that during the intermediate run, at least part of the electricity requirements of the method operating during the intermediate run is met from at least one electrochemical accumulator.

According to other optional aspects:
during the intermediate run, the high and/or medium voltage electricity consumption of the method is reduced, preferably once the supply from the accumulator has started;
the at least one electrochemical accumulator does not supply medium and/or high voltage electricity to the method during the first and second runs;
the at least one electrochemical accumulator no longer supplies medium and/or high voltage electricity to the method by the end of the intermediate run;
the electrochemical accumulator supplies the method during the intermediate run with a quantity of electricity which decreases over time;
the electricity grid supplies the method during the intermediate run with a quantity of electricity which decreases over time;
the electricity grid supplies the method during the intermediate run with a quantity of electricity equal to that supplied during the second run;
the difference between the electricity consumption of the air separation method in the first run and that in the second run is X MW, where X is a number greater than zero and the maximum quantity of electricity supplied during the intermediate run is at least 0.9X MW of electricity, preferably at least X MW of electricity;
the at least one electrochemical accumulator is supplied by the same electricity grid as the compressor or compressors of the method;
the electrochemical accumulator is charged with electricity when the price of electricity is below a threshold and/or when the electricity consumption is below a threshold and/or at night;
at least part of the electricity requirements of the method is met from an electrochemical accumulator in the event of a reduction in the quantity of electricity available on the grid;
the method comprises a step of boosting purified air in a booster driven by a motor, the boosted air serving to vaporize a liquid product of the distillation, wherein the boosted flow rate is the same during at least two of the three runs;
the method includes a step wherein the boosting of air is stopped; the total flow rate of air decreases (owing to reduction of the air booster which represents between 20 and 30% of the air) but the flow rate to the column operating at higher pressure remains quite constant;
liquefied air and/or a liquid product from the air separation device is stored during the first run;
liquefied air is sent from the storage means to the separation device during the second run and/or during the intermediate run;
a liquid product from the storage means is vaporized during the second run and/or during the intermediate run to supply a gaseous product;
liquefied air is not sent from the storage means to the separation device during the first run and/or during the intermediate run;
a liquid product from the storage means is not vaporized during the first run to supply a gaseous product;
the quantity of liquefied air sent from the storage means to the separation device is increased during the intermediate run;
the quantity of a vaporized liquid product from the storage means is increased during the intermediate run to supply a gaseous product;
a first flow rate of air is compressed in at least one compressor (C) to a pressure of at least 5 bar;
only during an intermediate run taking place after the first run and before the second run, at least part of the electricity requirements of the method operating during the intermediate run are met from at least one electrochemical accumulator;
no part of the electricity requirements of the method operating during the first and/or the second run are met from the at least one electrochemical accumulator;
electricity is sent to the method from the at least one accumulator if a load shed request is received from a control unit of an electricity production and consumption system supplying electricity to a plurality of consumers.

The subject matter of the invention, according to another aspect, is a device for separating air by cryogenic distillation comprising at least one compressor for compressing air, means for cooling and purifying the compressed air, a system of columns comprising at least one air distillation column for separating air into oxygen and nitrogen, a motor for driving at least one of the at least one compressors, means for supplying the motor with high and/or medium voltage electricity coming from a grid, at least one electrochemical accumulator, means for supplying the motor with high and/or medium voltage electricity coming from the at least one accumulator, means for interrupting the supply of electricity to the motor from the grid and means for interrupting the supply of electricity to the motor from the at least one accumulator, the means for interrupting the supply of electricity being controlled from a control system, means for sending a first flow rate of air to be compressed in the at least one compressor during a first run, means for sending a second flow rate of air lower than the first flow rate of air to be compressed in the at least one compressor during a second run, means for connecting the at least one accumulator to the motor during an intermediate run taking place after the first run and before the second run in response to a load shed request signal.

Thus, in response to a load shed request, preferably coming from a control unit, the device comprises means for connecting the at least one accumulator to the motor, such that the motor is powered partially by the at least one accumulator and partially by the electricity grid (partial load shed) or otherwise entirely by the at least one accumulator, at least during the intermediate run.

The device may comprise means for interrupting the sending of electricity from the at least one accumulator to the motor after a given time and/or according to a signal from the control unit.

Preferably, the device comprises means connected to the system of columns for supplying a product of the distillation and at least one cryogenic liquid storage means connected to these means. This allows constant production to be maintained even when the system of columns receives less air.

### BRIEF DESCRIPTION OF THE DRAWINGS

For a further understanding of the nature and objects for the present invention, reference should be made to the following detailed description, taken in conjunction with the accompanying drawings, in which like elements are given the same or analogous reference numbers and wherein:

FIG. 1 shows the evolution of various features of the method over time in graphs:
a) showing the power sent from the electricity grid to the air separation device over time;
b) showing the power sent to the air separation device from at least one accumulator over time;
c) showing the power consumption of the compressor or compressors of an air separation device over time;
d) showing the flow rate of oxygen gas produced over time.

FIG. 2 shows an air separation device according to the invention.

### DETAILED DESCRIPTION OF PREFERRED EMBODIMENTS

FIG. 1 shows variable parameters of a device for separating air by cryogenic distillation. This device forms part of a plurality of consumer units connected to an electricity production and consumption system supplying electricity to a plurality of consumers. This electricity grid R comprises a control unit adapted to transmit to the consumption units, including the air separation device, modulation instructions and in particular load shedding instructions.

These load shedding instructions may go via any appropriate means, for example a physical medium (PLC, radio, ADSL) or via the Internet.

As can be seen in FIG. 1 a), during a first run, the electricity grid R sends a first quantity of electricity H_{ASU} to a device for separating air by cryogenic distillation. This electricity is mainly used to operate the motor or motors of the compressor or compressors of the device, whether a main air compressor, an air booster, or a product compressor. During an intermediate run, the grid sends less electricity to the air separation device (quantity B_{ASU}).

At the instant to when the electricity supply drops FIG. 1 b), an electricity accumulator is switched on to supply the separation device, which is still operating at full rate of productivity, with the quantity of electricity lacking.

During an intermediate run between the first and the second run, at least part of the electricity requirements of the method is met from at least one electrochemical accumulator A and the consumption of electricity from the electricity grid is lower than that during the first run and greater than or equal to that during the second run.

Thus, just after the fall in the electricity supply from the grid, the air separation device is still supplied with the same quantity of electricity as during the first run.

The accumulator A operates during an intermediate run, for the time it takes the air separation method to adapt to the reduction in electricity coming from the grid. During this intermediate run, the production of electricity from the at least one accumulator A decreases regularly, reaching zero by the end of the intermediate run at the time t₁.

During the intermediate run, the production of electricity from the grid R is at a low value B corresponding to that of the second run (FIG. 1 a)).

As can be seen in FIG. 1 c), during the intermediate run, the consumption of the air separation method drops but does not begin to drop until the supply from the accumulator has been put in place, therefore after t₀.

The consumption of the air separation method drops during the intermediate run to a low value B_{ASU}, and the compressed flow rate of the main air compressor drops at the same time, such that the motor consumes less electricity. If the method includes a step of boosting feed air, this air being used to compress the air to vaporize a liquid product of the distillation, for example oxygen, the air booster may have a constant flow rate for at least two of the runs: first run, second run and intermediate run. Thus, the production of oxygen d) vaporized by the boosted air does not vary in this case. At least some oxygen may be supplied by a liquid oxygen storage means fed by a column of the separation device. Thus, as can be seen in FIG. 1 d), the total oxygen production OG does not vary, the quantity of oxygen missing from the production of the columns being supplied by the liquid oxygen storage means.

It is also possible to allow oxygen production to vary by letting it fall between t1 and t2, or between t0 and t3, if the customer can tolerate reductions in flow rate.

Preferably, a purified air booster is driven by a motor.

It is also possible to reduce the quantity of electricity supplied by the grid during the intermediate run, without however reducing it immediately to the value B_{ASU}. For example, the quantity of electricity supplied by the grid to the device may fall immediately to an intermediate value between H_{ASU} and B_{ASU}, or may fall regularly from T₀, reaching the value B_{ASU} only at t₁.

During the intermediate run, the high and/or medium voltage electricity consumption of the method is reduced, preferably once the supply from the accumulator has started.

When the accumulator no longer produces electricity, the method operates at low rate of productivity, possibly producing less product. In this case, the electricity consumption of the method falls before the production falls, owing to the time required to carry out the distillation.

The second run starts at time t1. During the second run, a second flow rate of air lower than the first flow rate of air is compressed in a compressor, the second flow rate is cooled and separated, a second flow rate of a first distillation product, possibly lower than the first flow rate of the first product, is produced, the high or medium voltage electricity requirements being lower than during the first run.

At time t₂ the grid again produces power at the initial quantity H. The accumulator begins to charge at t₂ or after t₂, finishing charging at t3. During this charging, the air separation device increases its power consumption, reaching the value H_{ASU} at t₃.

Once the accumulator is charged at t3, the consumption of the separation device is at H_{ASU} once more. Grid production does not change while the accumulator is charging.

The at least one electrochemical accumulator does not supply medium and/or high voltage electricity to the method during the first and second runs or optionally during the first or the second run.

The at least one electrochemical accumulator no longer supplies medium and/or high voltage electricity to the method by the end of the intermediate run.

The electrochemical accumulator supplies, during the intermediate run, a quantity of electricity which decreases over time.

The difference between the electricity consumption of the air separation method in the first run and that in the second run is X MW, where X is a number greater than zero and the maximum quantity of electricity supplied during the intermediate run is at least 0.9X MW of electricity, preferably at least X MW of electricity.

The at least one electrochemical accumulator is supplied by the same electricity grid as the compressor or compressors of the method.

Preferably, the electrochemical accumulator is charged with electricity when the price of electricity is below a threshold and/or when the electricity consumption is below a threshold and/or at night.

At least part of the electricity requirements of the method is met from an electrochemical accumulator in the event of a reduction in the quantity of electricity available on the grid.

The accumulator is not necessarily at the same site as the air separation device. The invention may also implement several accumulators and several air separation devices located at different sites but electrically connected to the same grid.

The invention may also be implemented to improve the balance, at any time, between the consumption of one or more air separation units and the production of one or more intermittent renewable electricity production facilities, such as wind or solar power facilities.

According to a variant, the method uses a liquefied air storage means and/or a liquefied product storage means. Liquefied air and/or a liquid product from the air separation device may be stored during the first run.

Depending on the requirements of a method, at least one of the following method steps is used:
liquefied air is sent from the storage means to the separation device during the second run and/or during the intermediate run;
a liquid product from the storage means is vaporized during the second run and/or during the intermediate run to supply a gaseous product;
liquefied air is not sent from the storage means to the separation device during the first run and/or during the intermediate run;
a liquid product from the storage means is not vaporized during the first run to supply a gaseous product;
the quantity of liquefied air sent from the storage means to the separation device is increased during the intermediate run;
the quantity of a vaporized liquid product from the storage means is increased during the intermediate run to supply a gaseous product;
a first flow rate of air is compressed in at least one compressor (C);
a first flow rate of air is compressed in at least one compressor (C) to a pressure of at least 5 bar.

The device comprises means for sending a first flow rate of air to be compressed in the at least one compressor during a first run, means for sending a second flow rate of air lower than the first flow rate of air to be compressed in the at least one compressor during a second run. These means consist of a pipe and regulation means.

The device also comprises means for connecting the at least one accumulator to the motor during the intermediate run taking place after the first run and before the second run in response to a load shed request signal.

The device is connected, for example, to a control unit which sends a load shed request signal to indicate that the air separation device should reduce its consumption of electricity from the grid.

In response to a load shed request, preferably coming from a control unit, means allow electricity to be sent from the at least one accumulator to the motor, such that the motor is powered partially by the at least one accumulator and partially by the electricity grid (partial load shed) or otherwise entirely by the at least one accumulator, at least during the intermediate run.

Means are also provided for interrupting the sending of electricity from the at least one accumulator to the motor after a given time and/or according to another signal from the control unit.

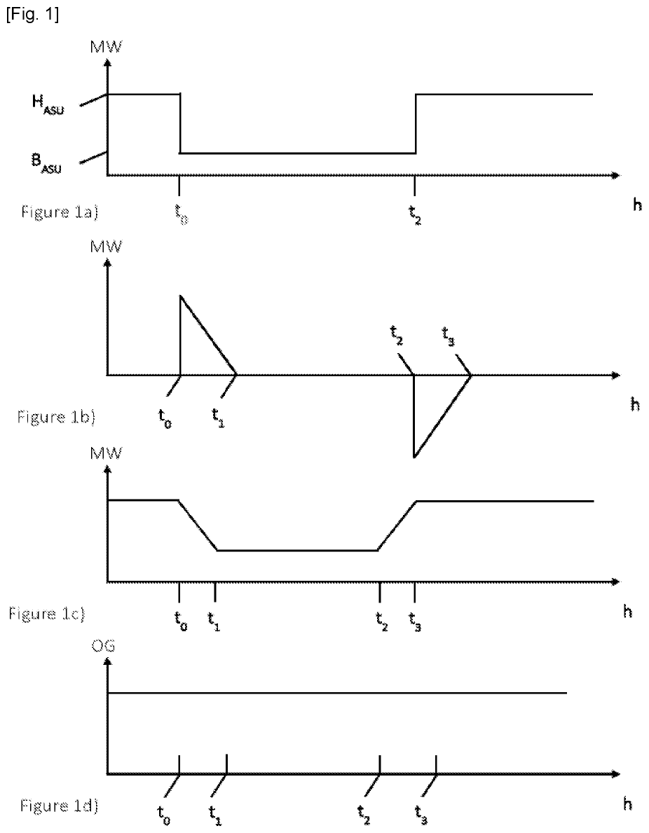

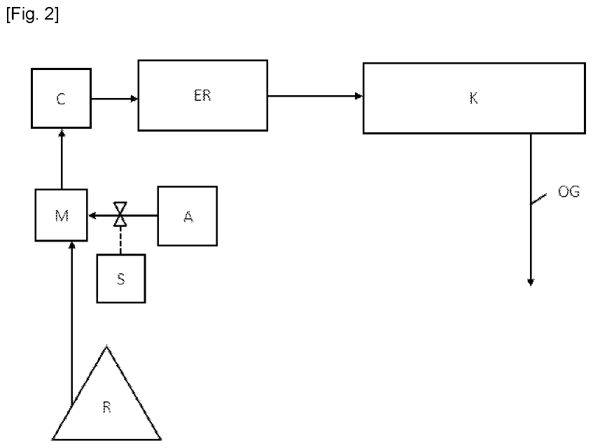

FIG. 2 shows an air separation device according to the invention. The device for separating air by cryogenic distillation comprises at least one compressor C for compressing air to a pressure of at least 5 bar, means ER for cooling and purifying the compressed air, a system of columns K comprising at least one air distillation column for separating air into oxygen OG and nitrogen, a motor M for driving at least one of the at least one compressors, means for supplying the motor with high and/or medium voltage electricity coming from a grid R, at least one electrochemical accumulator A, means for supplying the motor with high and/or medium voltage electricity coming from the at least one accumulator, means for interrupting the supply of electricity to the motor from the grid and means for interrupting the supply of electricity to the motor from the at least one accumulator, the means for interrupting the supply of electricity being controlled from a control system S. This control system may be the electricity grid control unit.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

1.-14. (canceled)

15. A method for separating air by cryogenic distillation wherein, during a first run, a first flow rate of air is compressed in at least one compressor, cooled and separated in a system of columns, a first flow rate of a first distillation product is produced, high or medium voltage electricity requirements of the compressor or compressors of the method are met from an electricity grid, during a second run, a second flow rate of air lower than the first flow rate of air is compressed in the at least one compressor, the second flow rate is cooled and separated in the system of columns, a second flow rate of a first distillation product is produced from the system of columns, lower than the first flow rate of the first product, high or medium voltage electricity requirements of the compressor being lower than during the first run and, during an intermediate run taking place after the first run and before the second run, the consumption of electricity from the electricity grid of the compressor or compressors is lower than that during the first run and greater than or equal to that during the second run, characterized in that during the intermediate run, at least part of the electricity requirements of the method operating during the intermediate run is met from at least one electrochemical accumulator.

16. The method as claimed in claim 15, wherein during the intermediate run, the high and/or medium voltage electricity consumption of the method is reduced, preferably once the supply from the accumulator has started.

17. The method as claimed in claim 15, wherein the at least one electrochemical accumulator does not supply medium and/or high voltage electricity to the method during the first and/or the second runs.

18. The method as claimed in claim 15, wherein the at least one electrochemical accumulator no longer supplies medium and/or high voltage electricity to the method by the end of the intermediate run.

19. The method as claimed in claim 18, wherein the electrochemical accumulator supplies, during the intermediate run, a quantity of electricity which decreases over time.

20. The method as claimed in claim 15, wherein the difference between the electricity consumption of the air separation method in the first run and that in the second run is X MW, where X is a number greater than zero and the maximum quantity of electricity supplied during the intermediate run is at least 0.9X MW of electricity.

21. The method as claimed in claim 15, wherein the at least one electrochemical accumulator is supplied by the same electricity grid as the compressor or compressors of the method.

22. The method as claimed in claim 15, wherein the electrochemical accumulator is charged with electricity when the price of electricity is below a threshold and/or when the electricity consumption is below a threshold and/or at night.

23. The method as claimed in claim 15, wherein at least part of the electricity requirements of the method is met from an electrochemical accumulator in the event of a reduction in the quantity of electricity available on the grid.

24. The method as claimed in claim 15, comprising a step of boosting purified air in a booster driven by a motor, the boosted air serving to vaporize a liquid product of the distillation, wherein the boosted flow rate is the same during at least two of the three runs.

25. The method as claimed in claim 15, wherein the electricity grid supplies the method during the intermediate run with a quantity of electricity which decreases over time.

26. The method as claimed in claim 15, wherein the electricity grid supplies the method during the intermediate run with a quantity of electricity equal to that supplied during the second run.

27. A device for separating air by cryogenic distillation comprising at least one compressor for compressing air, a means for cooling and purifying the compressed air, a system of columns comprising at least one air distillation column for separating air into oxygen and nitrogen, a motor for driving at least one of the at least one compressors, a means for supplying the motor with high and/or medium voltage electricity coming from a grid, at least one electrochemical accumulator, a means for supplying the motor with high and/or medium voltage electricity coming from the at least one accumulator, a means for interrupting the supply of electricity to the motor from the grid and a means for interrupting the supply of electricity to the motor from the at least one accumulator, the means for interrupting the supply of electricity being controlled from a control system, a means for sending a first flow rate of air to be compressed in the at least one compressor during a first run, a means for sending a second flow rate of air lower than the first flow rate of air to be compressed in the at least one compressor during a second run, a means for connecting the at least one accumulator to the motor during an intermediate run taking place after the first run and before the second run in response to a load shed request signal.

28. The device as claimed in claim 27, comprising means connected to the system of columns for supplying a product of the distillation and at least one cryogenic liquid storage means connected to these means.
